(19) United States
(12) Patent Application Publication
(10) Pub. No.: US 2011/0239403 A1
(43) Pub. Date: Oct. 6, 2011

(54) Fitting

(75) Inventors: Oliver Walhorn, Werther (DE); Thomas Vogler, Bad Salzuften (DE)

(73) Assignee: Dorma GmbH + Co. KG, Ennepetal (DE)

(21) Appl. No.: 13/132,372

(22) PCT Filed: Nov. 24, 2009
(86) PCT No.: PCT/EP2009/008354

§ 371 Date: Jun. 2, 2011

(30) Foreign Application Priority Data
Dec. 2, 2008 (DE) 10 2008 059 926.3
Feb. 11, 2009 (DE) 10 2009 008 401.0
Nov. 10, 2009 (DE) 10 2009 052 418.5

(51) Int. Cl. E05D 11/00; F16B 2/06

(52) U.S. Cl. 16/225; 24/457

(57) ABSTRACT

A fitting for rotatably or displaceably supporting swing leaf doors or sliding doors, including a lower fitting part configured to be attached to the door leaf. The lower fitting part is fastened to a hinge strap or to an adapter support by a fastener. The fitting includes a transponder, which serves to identify the fitting.

### PRIORITY CLAIM

This is a U.S. national stage of Application No. PCT/EP2009/008354, filed on Nov. 24, 2009, which claims priority to German Application Nos: 10 2008 059 926.3, filed: Dec. 2, 2008, 10 2009 008 401.0, filed Feb. 11, 2009, and 10 2009 052 418.5, filed Nov. 10, 2009, the contents of which are incorporated herein by reference.

### BACKGROUND OF THE INVENTION

1. Field of the Invention

The present invention relates to a fitting for rotatably or displaceably supporting swing leaf doors or sliding doors, comprising a lower fitting part to be attached to the door leaf, wherein the lower fitting part is fastened to a hinge strap or to an adapter support with the help of a fastener.

2. Related Art

Fittings for swing leaf doors or sliding doors are generally connected to the door by clamping the door leaf or by of a bore in the door leaf. The functions of the multitude of fittings available on the market are considered as almost equal such that very often merely the design and the manufacturing quality are decisive factors. Failure of the fittings very often results in unexpected consequences for the user, in particular with glass doors which will break, and then the user might injured by the glass splinters. As fittings can be manufactured at very little technical expense, it is easy to counterfeit genuine products and to sell them at lower quality. It is then difficult for the manufacturer to distinguish the original from the counterfeit product.

Another problem with bonded fittings is the necessary safety for the user of the glass door. Failure of a bonded fitting leads in many cases to damaging or to breaking the glass door, whereby the user might incur serious injury. This risk is particularly high with shower doors made of glass. The manufacturer of the bonded fitting or of the door encounters the problem of having to determine the cause and to respond to warranty claims.

### SUMMARY OF THE INVENTION

It is an object of one embodiment of the invention to provide a fitting, which allows for identification and in which all the manufacturing parameters can be stored.

One embodiment of the invention is characterized in that the fitting includes a transponder that allows for identifying the manufacturing parameters and the distribution chain. A consecutive serial number allows for exactly allocating the manufacturing parameters, place of manufacture and customer or wholesale merchant. The data can be retrieved via an Internet database such as to be able to verify at any time whether or not it is a genuine fitting and under which manufacturing parameters it was sold. Thereby warranty claims can be settled fast. The invention can be utilized in all types of fittings and in all doors, for example made of wood, metal, plastic material or glass.

In order to allow for quick and inexpensive storing of data during series production, a portion of the adapter is made from plastic material at or in which the transponder is disposed. As metallic structural components have a shielding or even insulating effect on data transmission, at least one structural component of the fitting should consist of plastic material such that the data can be stored already prior to mounting or completing the fitting.

The transponder is incorporated into the plastic material by a capsule, wherein the capsule protects the electronic components during the manufacturing operation. The transponder is embedded with the capsule into the plastic material during the manufacturing operation to allow for an inexpensive manufacturing.

The lower fitting part can be attached to the door leaf by clamping—like with a roller carriage of a sliding door—or by a bore. A compact and design-oriented solution consists in bonding the lower fitting part to the door leaf, whereby a low construction height is achieved for a roller carriage and a filigree disposition without a glass bore for a swing leaf door.

A preferred embodiment is achieved in that the lower fitting part is configured as an adhesive adapter, which consists of glass-fiber-reinforced polyamide. In particular for glass doors, the glass fibers protruding from the adhesive adapter achieve a glass-to-glass bonding, which results in a high quality and durable adhesive bond.

Another improvement is the result if the glass fiber portion is to the amounts of 50% to 70%, preferably of 60%. In this case, the plastic material serves as the support material for the glass-fibers. The above described glass-fiber portion provides the adapter with sufficient stability in order to carry a door via a hinge strap or via an adapter support.

In one embodiment a metallic adhesive adapter with a metallic bonding surface is provided with a coating of plastic material, in which the transponder is incorporated by a capsule.

A reproducible adhesive bond is achieved in that the adhesive adapter has a bonding surface and a counter-surface, wherein at least one web is disposed on the bonding surface, by which web the thickness of the adhesive layer is determined.

In this case, the webs may be configured as neps, stripes, or rings, which are very easily and inexpensively to manufacture.

A stable fitting, which is able to bear load, is realized in that an insert with a thread is incorporated into the adhesive adapter, wherein the thread is accessible from the counter-surface. The insert is directly embedded into the adhesive adapter during the injection-molding process and allows for a long life span without the thread experiencing any wear and tear.

Another improvement is achieved in that the thread of the insert is configured as a through-hole thread, the core removing hole continuing in the adhesive adapter. When screwing the fastener in, they cut a thread into the core removing hole, whereby an inexpensive and integral self-locking system is created.

Another measure enhancing the stability is achieved in that the insert has an undercut, which effects anchoring in the plastic material of the adhesive adapter.

As the counter-surface is chamfered towards the border of the adhesive adapter, a demoulding diagonal is created at the same time for the manufacturing process of the adhesive adapter during injection-molding of plastic material.

Fastening the adhesive adapter to the door leaf is realized by a UV-hardening and light-hardening acrylate adhesive. This adhesive is permanently resistant to aging.

To compensate for tolerances, a device for a vertical and/or horizontal and/or axial adjustability are disposed between the adhesive adapter and the hinge strap or the adapter support.

### BRIEF DESCRIPTION OF DRAWINGS

Hereinafter, further measures enhancing the invention will be illustrated in detail in conjunction with the description of one preferred embodiment of the invention based on the Figures, in which:

FIG. 1: is a perspective illustration of a pivot fitting with an adhesive adapter;

FIG. 2: is a lateral sectional illustration through the adhesive adapter;

FIG. 3: is a perspective illustration of the bonding surface of the adhesive adapter;

FIG. 4: is a perspective illustration of the fastening side of the adhesive adapter;

FIG. 5: is another variant of an adhesive adapter;

FIG. 6: is another variant of a metallic adhesive adapter;

FIG. 7: is a roller carriage for a sliding door to be connected to the adhesive adapter; and

FIG. 8: is the roller carriage with the adhesive adapter glued to a sliding door.

### DETAILED DESCRIPTION OF DRAWINGS

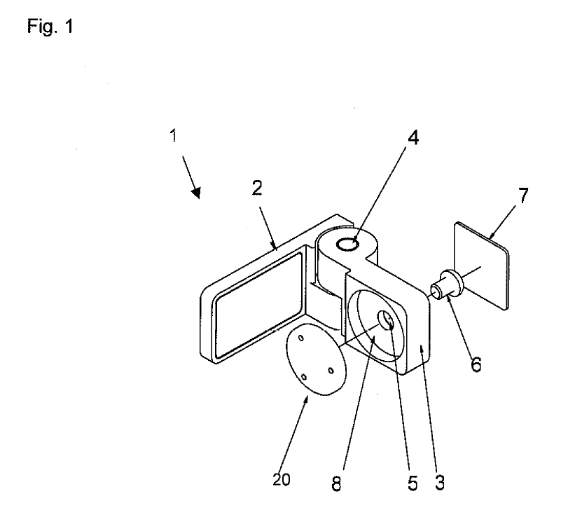

In FIG. 1, a fitting 1 with a first hinge strap 2 and a second hinge strap 3 is illustrated, which are rotatably connected to each other via a pivot 4. In this embodiment, the first hinge strap 2 is configured as an attachment to a wall or to a casing. The second hinge strap 3 has a depression 8 for accommodating an adhesive adapter 20. In this embodiment, the adhesive adapter 20 is configured as a circular or round disc. Furthermore, the second hinge strap 3 has a bore 5, through which a fastening element 6 can pass and be screwed to the adhesive adapter 20. The fastening element 6 may then be closed by a cover cap 7. The depression 8 and the bore 5 are dimensioned with regard to the diameter of the fastening element 6 and of the adhesive adapter 20 in such a way that horizontal and/or vertical adjustability of the fitting 1 in relation to the adhesive adapter 20 is possible. In order to achieve tolerance compensation in the direction of the glass door, namely in axial direction to the fastening element 6, non-illustrated spacer rings may be inserted between the adhesive adapter 20 and the second hinge strap 3.

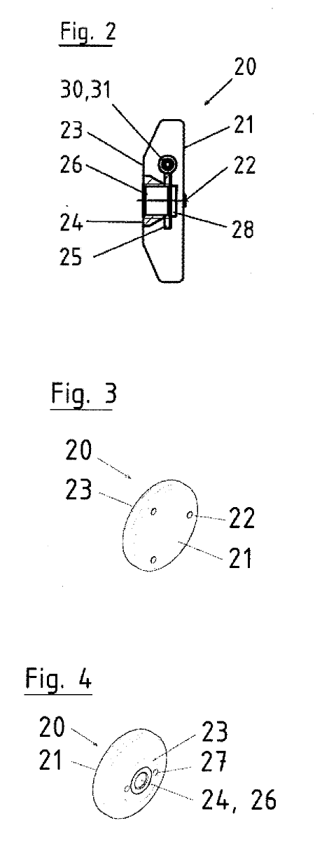

The lateral sectional illustration through the adhesive adapter 20 in FIG. 2 shows a bonding surface 21, which may have one or several webs 22. The webs 22, are configured as neps, as stripes, or as a ring, and are disposed on the bonding surface 21. The height of each of the webs 22 corresponds to the thickness of the adhesive layer. Reproducibility is thereby provided in terms of amount and thickness of the adhesive layer, because this influences the other parameters for hardening the adhesive. An insert 24 with a thread 26 is incorporated into the counter-surface 23. As the adhesive adapter 20 consists of plastic material, the insert 24 has an undercut 25 that guarantees a better embedding in the adhesive adapter 20. It is obvious that the thread 26 corresponds to the fastening element 6. Furthermore, a capsule 30 with a transponder 31 is incorporated into the adhesive adapter 20. The capsule 30 is recessed into the plastic material mixture during the manufacturing process of the adhesive adapter 20. The counter-surface 23 is chamfered towards the border of the adhesive adapter 20, whereby simultaneously a demoulding diagonal is provided for the manufacturing process.

The thread 26 may be configured as a through-hole thread. The core removing bore 28 of the thread 26 continues in the adhesive adapter 20. When screwing the fastening elements 6 and 13 in for the first time, the thread of the fastening elements 6 and 13 passes through the thread 26 of the insert and, with the first thread turns, cuts a thread into the core removing hole 28. An inexpensive and integral self-locking is thereby created for the fastening elements 6 and 13.

FIG. 3 illustrates the bonding surface 21 with the webs 22. In this embodiment, three webs 22 are uniformly disposed on the bonding surface 21. The webs 22 are point-shaped or configured as neps.

FIG. 4 shows the counter-surface 23 of the adhesive adapter 20. Two bores 27 are machined into the area of the insert 24, respectively the thread 26, into which bores pins of a fitting member or of a hinge strap 3 can engage as an anti-rotation protection.

The adhesive adapter 20 may consist of plastic material which is reinforced by glass-fibers. Usually the mating of the materials glass and plastic allows only for inadequate bonding. A glass-fiber-reinforced polyamide is used as the plastic material, which consists of 50 to 70%, preferably of 60% of glass fibers. During the injection-molding of the plastic material into the tool and during subsequent hardening, glass fiber ends protrude in a random arrangement from the adhesive adapter 20. This results in the effect that in principle glass is bonded to glass, which is a perfect mating of materials for this connecting method. In this case, the plastic material serves as the support material. The diagonal of the counter-surface 23, disposed towards the border of the adhesive adapter 20, serves at the same time as demoulding diagonal for the injection-molding process by which the adhesive adapter 20 is manufactured. The capsule 30 with the transponder 31 is simultaneously inserted into the adhesive adapter 20 during the manufacturing process.

Bonding between the bonding surface 21 and the glass surface is realized by a colorless UV-hardening and light-hardening acrylate adhesive, which as a solvent-free one component adhesive has the required resistance to aging. In this case, the bonding exclusively takes place on the door leaf without utilizing a front edge of the door.

In order to prove reproducibility of the adhesive layer, in addition to the thickness of the adhesive layer, other manufacturing parameters, such as humidity, temperature of the glass, setting time and setting temperature need to be documented. This documentation is stored in the transponder 31, which is incorporated in a capsule 30 into the adhesive adapter 20. During the manufacturing process of the adhesive bond, this data is computer-controlled and stored in the transponder. In this case, each adhesive fitting receives a continuous manufacturing number, which can be retrieved via an internet data base, among others with indication of the place of manufacturing and the customer. It is thereby possible to ensure at any time, that the present fitting, at which the bonding spot might have failed, is a genuine product to ensure warranty claims. The transponder 31 thus serves at the same time as a hidden copy protection, because especially glass fittings are easy to produce as copies or as a counterfeit products. Active or passive transponders based on RFID-technology can be utilized as the transponders 31. On account of the low performance of the RFID-technology, incorporating a transponder 31 into a metal fitting has its limitations. An adhesive adapter exclusively made of metal would have such a high insulation effect, that it would be very expensive to read the transponder 31. Therefore, a combination of an adhesive adapter 20, in which the transponder 31 is incorporated into the plastic material, is optimal, because incorporating the transponder 31 by capsule 30 during the injection-molding process is very easily and inexpensively realized, and automatic storing of the required parameters is possible during the manufacturing process.

Another embodiment of the adhesive adapter 20 is illustrated in FIG. 5. This adhesive adapter 20 essentially consists, according to the state-of-the-art, of a metal structural component, the metal bonding surface 21 thereof being attached to the door leaf by bonding. A thread 26, which corresponds to the fastening elements 6 and 13, is incorporated into the adhesive adapter 20. In order to incorporate the transponder 31 into the fitting, the adhesive adapter 20 is provided with a coating 29 of plastic material in which the transponder is concealed by a capsule 30. In this embodiment, the border area of the adhesive adapter 20 and the surface facing away from the door leaf are provided with a coating 29 of plastic material. This adhesive adapter 20 can be provided for example with point-shaped webs 22, which ensure a uniform thickness of the adhesive layer. Furthermore, the counter-surface 23 of the adhesive adapter 20 may be provided with a demoulding diagonal which simplifies the manufacturing process.

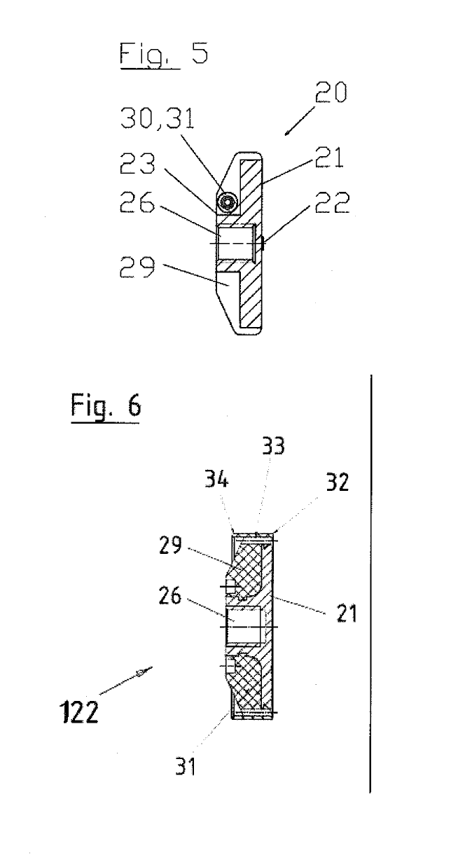

Essential parts of the embodiment in FIG. 6 correspond to the embodiment according to FIG. 5. In this case again, an adhesive adapter 122 is configured with a metal bonding surface 21 and is embedded into a coating 29 of plastic material. A transponder 31 is incorporated into the plastic material coating 29. Towards the bonding surface 21, the coating 29 has a surrounding elevated edge 32, which protrudes beyond the bonding surface 21. The height of the edge 32 may be configured such that—analogously to the webs 22—the thickness of the adhesive layer is thereby determined. As the edge 32 deforms during the bonding process when pressing the adhesive adapter 122 onto the door surface and as the space for the still liquid adhesive layer thus becomes smaller, one or more bores 33 are machined on the surface of the coating 29 in spatial vicinity to the edge 32, which are meant to discharge the excess liquid adhesive, respectively excess air from the bonding surface 21. On the rear side of adhesive adapter 122, in the area of the counter-surface 23, another surrounding edge 34 is disposed at the exterior circumference of the coating 29, which should prevent the discharged adhesive from dripping down the exterior wall of the adhesive adapter 122 and thus prevent it from soiling the surface of the door. Once the bonding process is completed, in which the edge 32 is deformed and compressed, the latter bears flush against the surface of the door and thus prevents water or cleaning products from penetrating into the bonding surface 21.

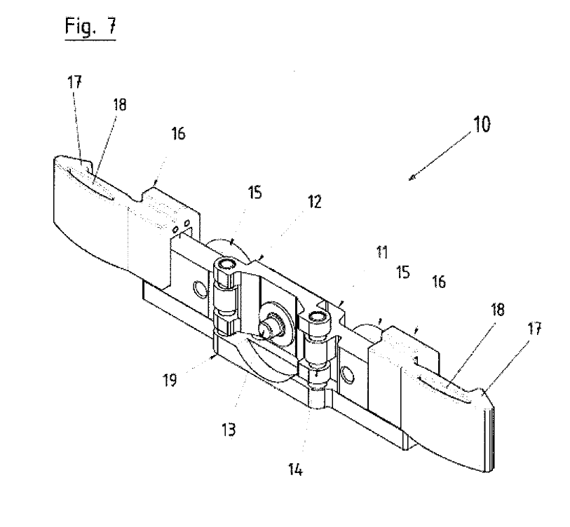

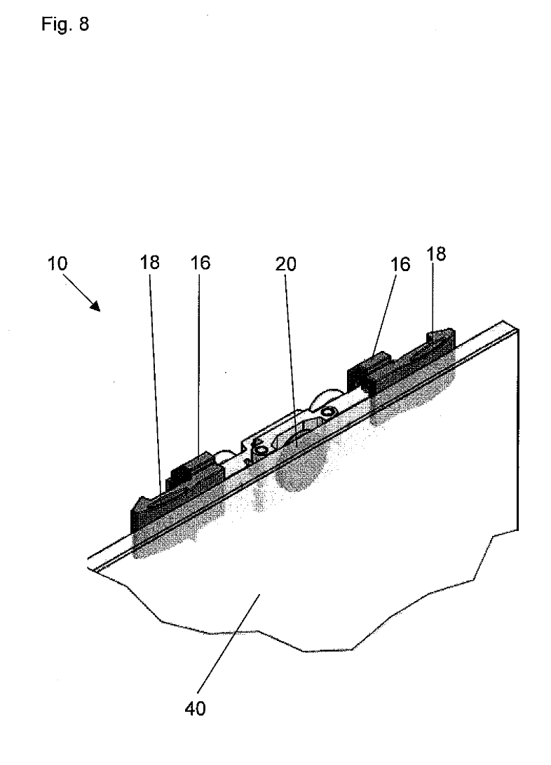

FIG. 7 shows an inventive fitting for a sliding door 40, shown in FIG. 8, which has a connection to an adhesive adapter 20. The illustrated roller carriage 10 shows a roller support 11, at which two rollers 15 are disposed for the roller rails. Via an adjusting device 14, the roller support 11 is connected to an adapter support 12 such that a vertical adjustability is possible for adjusting the height of the door. A fastening element 13, which engages in the thread 26 of the adhesive adapter 20, is rotatably attached to the adapter support 12. The adapter support 12 is configured in a concave shape to accommodate the adhesive adapter 20 to create a reception space for the adhesive adapter 20 by which the least possible construction depth is achieved. Also the disposition of the adapter support 12 between the rollers 15 ensures that the construction depth of the roller carriage 10 is minimized. In order to accommodate the rollers 15, the roller support 11 has indentations, respectively a step, able to receive at least a portion of the construction depth of the rollers 15. The bottom of the roller carriage 10 is shielded by a screen 19. On one side or on both sides, the roller support 11 may be provided with a lift-off protection 16. In this case, the lift-off protection 16 may be fitted onto the roller support 11 and be attached thereto. In this way, the roller support 11 may be retrofitted with one or two lift-off protections 16. A hook 17, for engaging with a stopper or a limit stop, is disposed at the lift-off protection 16. Furthermore, the lift-off protection 16 has a buffer 18, which dampens potential impacting of the sliding door against a limit stop. In order to achieve tolerance compensation in the direction of the glass door, non-illustrated spacers can be inserted between the adhesive adapter 20 and the adapter support 12.

The connection of the roller carriage 10 to a sliding door 40 is illustrated in FIG. 8. In this case, the adhesive adapter 20 is glued to the door leaf. The roller carriage 10 is mounted to the adhesive adapter 20 via the fastening element 13. In this case, the roller carriage 10 is rotatably supported about the fastening element 13 such as to realize compensation towards a roller rail or to compensate a non-uniformly suspended sliding door. In this case, the sliding door 40 may freely pivot about the axis of the fastening element 13. The exterior surfaces of the buffers 18 of the lift-off protection 16 bear resiliently against the sliding door 40 and eliminate the play resulting from the connection of the adhesive adapter 20 to the roller carriage 10.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-20. (canceled)

21. A fitting for one of rotatably and displaceably supporting a door leaf, comprising:
one of a hinge strap and an adapter support;
lower fitting part configured to be attached to the door leaf, wherein the lower fitting part is fastened to the one of the hinge strap and the adapter support by a fastener; and
a transponder that identifies the fitting arranged in the fitting.

22. The fitting according to claim 21, wherein at least part of the fitting is a plastic material one of at or in which the transponder is disposed.

23. The fitting according to claim 22, wherein the transponder is disposed in the plastic material by a capsule.

24. The fitting according to claim 23, wherein the transponder together with the capsule is embedded into the plastic material during a manufacturing operation.

25. The fitting according to claim 21, wherein the lower fitting part is attached to the door leaf by one of clamping and a bore.

26. The fitting according to claim 21, wherein the lower fitting part is attached to the door leaf by bonding.

27. The fitting according to claim 26, wherein the lower fitting part is configured as an adhesive adapter comprising glass-fiber-reinforced plastic material.

28. The fitting according to claim 27, wherein the adhesive adapter comprises glass-fiber-reinforced polyamide, wherein the glass-fiber portion is to the amount of 50% to 70%.

29. The fitting according to claim 26, wherein the lower fitting part is configured as an adhesive adapter comprising a metallic element with a metallic bonding surface and a coating of plastic material into which the transponder is incorporated by a capsule.

30. The fitting according to claim 27, wherein the adhesive adapter has a bonding surface and a counter-surface opposite the bonding surface, wherein at least one web is disposed on the bonding surface by which a thickness of the adhesive layer is determined.

31. The fitting according to claim 30, wherein the at least one web is configured as one or more neps, stripes, and rings.

32. The fitting according to claim 30, wherein an insert with a thread is incorporated into the adhesive adapter, the thread being accessible from the counter-surface.

33. The fitting according to claim 32, wherein the insert has an undercut.

34. A fitting according to claim 32, wherein the thread is configured as a through-hole thread, the core removing hole thereof continuing in the adhesive adapter.

35. The fitting according to claim 30, wherein the counter-surface is chamfered towards the border of the adhesive adapter.

36. The fitting according to claim 26, wherein the lower fitting part is bonded to the door leaf by a UV-hardening and light-hardening acrylate adhesive.

37. The fitting according to claim 21, wherein at least one adjuster is disposed between the lower fitting part and one of the hinge strap and the adapter support.

38. The fitting according to claim 29, wherein, in the area of its exterior circumference, the coating has a surrounding edge that protrudes beyond the bonding surface.

39. The fitting according to claim 38, wherein the coating, in the area of its exterior circumference, has at least one bore for discharging air or adhesive from the bonding surface.

40. The fitting according to claim 38, wherein, on the rear side of the adhesive adapter in the area of the counter-surface, a surrounding edge is disposed at the exterior circumference of the coating.
